(19) United States
(12) Patent Application Publication
(10) Pub. No.: US 2006/0294402 A1
(43) Pub. Date: Dec. 28, 2006

(54) User permission using power button

(76) Inventor: David Poisner, Folsom, CA (US)

Correspondence Address: CARRIE A. BOONE, P.C., 2450 LOUISIANA, SUITE 400-310, HOUSTON, TX, 77006, US

(21) Appl. No.: 11/166,665

(22) Filed: Jun. 25, 2005

(51) Int. Cl. G06F 1/00

(52) U.S. Cl. 713/300

(57) ABSTRACT

A system and method for using the power button of a processor-based system to grant permission is disclosed, thus facilitating secure remote access to the system. Other embodiments are described and claimed.

### FIELD OF THE INVENTION

This invention relates to a user-accessible power button on a processor-based system and, more particularly, to alternate use of the button.

### BACKGROUND OF THE INVENTION

Processor-based systems, such as personal computers, typically include one or more user-accessible buttons for changing the state of the system. A power button, for example, may be located on the front panel of the system, enabling the user to turn the system on.

The processor-based system may include multiple user-accessible buttons, enabling further control of the system. A standby or sleep button may be depressed when putting the system in a low-power state. Separate volume external/internal video or audio, etc., buttons may provide the user with maximum control of the system. Multiple user-accessible buttons may be found on laptop systems in particular.

More likely, however, the front panel only includes a single user-accessible button. Such is the case with most desktop systems. The single button enables the user to put the system in multiple states or modes. The button may also be associated with visual indicators, such as one or more light-emitting diodes (LEDs), to visually inform the user of the system state.

In many desktop systems, the user-accessible button, known herein as the power button, provides three system states: power-on, standby (sleep), and power-off. Power-on is available when the processor-based system is in an off state. Standby is available when the processor-based system is in an on state, but the user wants to put the system into a low-power state.

Power-off is also available from the power button when the system is in an on state. Typically, the system is set to an off state by the operating system at the user's request (software power-off). Sometimes, however, the system needs to be set to an off state by disabling power to the system, such as during an unrecoverable hang of application or operating system software. In lieu of unplugging the processor-based system from the wall, the user may depress the power button for an extended time period (usually, four seconds) to remove power from the system. Since this operation overrides the “normal” use of the button during power-on (that is, to put the system in standby mode), the third button operation is known as a “forced power-off” or “power button override” operation.

There are circumstances in which the user may need to “prove” his/her presence before specific steps are taken in the processor-based system. For example, access to the system by a remote source may be desirable, such as to diagnose problems and perform remediation of the system. Where the system is to be remotely controlled, it is desirable to have the user provide some explicit indication, a “permission,” for the system to be remotely controlled. Otherwise, the user has lost “control” of the system.

Providing the permission for the remote control of a processor-based system is not trivial. Obtaining the permission via a sequence of key strokes, or a click of a screen icon, for example, leaves the system vulnerable to malicious software, or malware, that is able to capture the keystrokes or simulate the mouse movement. In corporate environments, such risks may be relatively low, due to the presence of technologies, such as firewalls, which protect the enterprise from outside interference. In residential or public environments, such protections are less common. A notebook system used at a “wired” public kiosk or a home system, for example, may not include such protective technologies.

Thus, there is a continuing need for a method to grant permission for remote control of or access to a processor-based system.

### BRIEF DESCRIPTION OF THE DRAWINGS

FIG. 1 is a block diagram of a processor-based system, according to the prior art;

FIG. 2 is a block diagram of a processor-based system, according to one embodiment;

FIG. 3 is a flow diagram of a first usage model of the processor-based system of FIG. 2, according to one embodiment;

FIG. 4 is a flow diagram of a second usage model of the processor-based system of FIG. 2, according to one embodiment;

FIG. 5 is a block diagram of a front panel of a processor-based system, according to one embodiment; and

FIG. 6 is a block diagram of a front panel of a processor-based system, according to one embodiment.

### DETAILED DESCRIPTION

In accordance with the embodiments described herein, a system and method for employing a user-accessible button of a processor-based system to grant permission for remote access is disclosed. The user-accessible button, or power button, maintains the functionality of legacy processor-based systems, except during a limited time period which is controlled by the user of the processor-based system. When the user depresses the power button during the limited time period, alternative operations are performed. The alternative operations may include the execution of local diagnostics, the granting of access to a remote entity, or other operations.

The alternate meaning of the power button is temporary; thus, the ability to initiate power-on, power-off, and standby modes of legacy processor-based systems using the power button is maintained. The enhanced power button provides a secure method for granting permission by the user of the processor-based system, thus facilitating remote access to the system.

In the following detailed description, reference is made to the accompanying drawings, which show by way of illustration specific embodiments in which the invention may be practiced. However, it is to be understood that other embodiments will become apparent to those of ordinary skill in the art upon reading this disclosure. The following detailed description is, therefore, not to be construed in a limiting sense, as the scope of the present invention is defined by the claims.

Reference throughout this specification to “one embodiment” means that a particular feature, structure, or characteristic described herein is included in at least one embodiment of the invention. Multiple references to “one embodiment” in this document are not meant to necessarily refer to a single embodiment, as each reference may denote to a different embodiment. Further, the features, structures, or characteristics described herein as being part of “one embodiment” may be combined in any suitable manner in one or more embodiments.

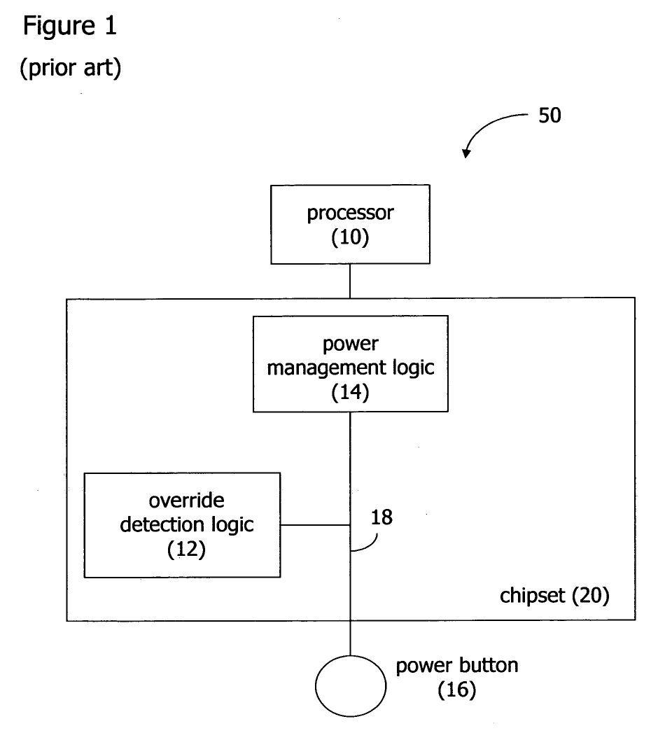

In FIG. 1, a processor-based system 50 is depicted, according to the prior art. The processor-based system 50 includes a processor 10 and a chipset 20. Other features of the processor-based system, such memory, video, and drive media subsystems, network interface controller (NIC), input devices, and other components, may be present in the processor-based system 50, although they are not featured in FIG. 1.

The chipset 20 is electrically connected to a power button 16, which is user-accessible and typically located on the front panel of the processor-based system. When the power button 16 is depressed by the user, the chipset 20 controls the routing of the resulting electrical signal 18 to other parts of the processor-based system.

The power button 16 connects directly to circuitry on the motherboard, such as a multi-purpose chipset. When the power button is depressed while the processor-based system 50 is in an off state, the chipset 20 signals to the power supply to turn on power to the rest of the system, at which point the processor 10 initiates a built-in self test (BIST) and executes the basic input/output firmware (BIOS). (The BIOS completes the power-on initialization of the processor-based system.) When the system 50 is in an on state and the power button 16 is depressed, the chipset 20 will invoke the power management logic 14, causing the system to enter a low power, or standby, mode. When the system 50 is in an on state and the power button 16 is pressed for an extended period of time, the chipset 20 will cause power to the processor-based system 50 to be set to an off state.

Among other logic not shown in FIG. 1, the chipset 20 includes power management logic 14 and override detection logic 12. Power management has been a feature of processor-based systems for many years. Power management logic may turn off subsystems, such as drive media and video, following user-specified periods of non-use, in order to reduce power consumption. Often, the user may control the operation of the power management logic by executing diagnostic or operating system software. The power management logic 14 may conform to the advanced configuration and power interface (ACPI) standard, or to some other protocol. (ACPI is an open industry specification co-developed by Hewlett-Packard, Intel, Microsoft, Phoenix, and Toshiba Corporations; the Advanced Configuration and Power Interface Specification, revision 2.0c, was published on Aug. 25, 2003, and is available on the web at http://www.acpi.info/.)

When the power button 16 is depressed, a signal 18 is transmitted to the power management logic 14. The power management logic 14 will process the request, whether by initiating the power-on sequence or by initiating a standby mode sequence, depending on the current state of the system 50. (It is possible that the standby request may not be honored.) The user of the processor-based system 50 presses the power button 16 to wake the system (if the system is asleep). If the system 50 is on, pressing the power button 16 provides a notification to software on the system that the user is requesting the system to be put in a low-power, or standby, state. Ultimately, it is up to power management software or firmware to honor or reject the user request.

If the user depresses the power button 16 for at least four seconds (or some other predetermined time period), the chipset 20 unconditionally proceeds to the off state, independent of the behavior of the system software (power button override). In this circumstance, the override detection logic 12 within the chipset 20 initiates the forced power-off of the processor-based system 50.

Table 1 is an examination of the power button operations described above. The table shows the “system state” of the processor-based system 50, the “power button action” taken by the user, and the “resulting system state,” according to the prior art. The power button operation designated “short press” is meant to indicate action by the user in which the button press is instantaneous or nearly instantaneous. The power button action designated “long press” is meant to indicate that the user has depressed the power button for a pre-determined time, or longer (which, in some systems, is four seconds).

TABLE 1
Power Button Operation

| system states | power button action | resulting system state |
|---|---|---|
| OFF | short press | ON |
| OFF | long press | OFF |
| ON | short press | standby mode |
| ON | long press | OFF |
| standby mode | short press | ON |
| standby mode | long press | OFF |

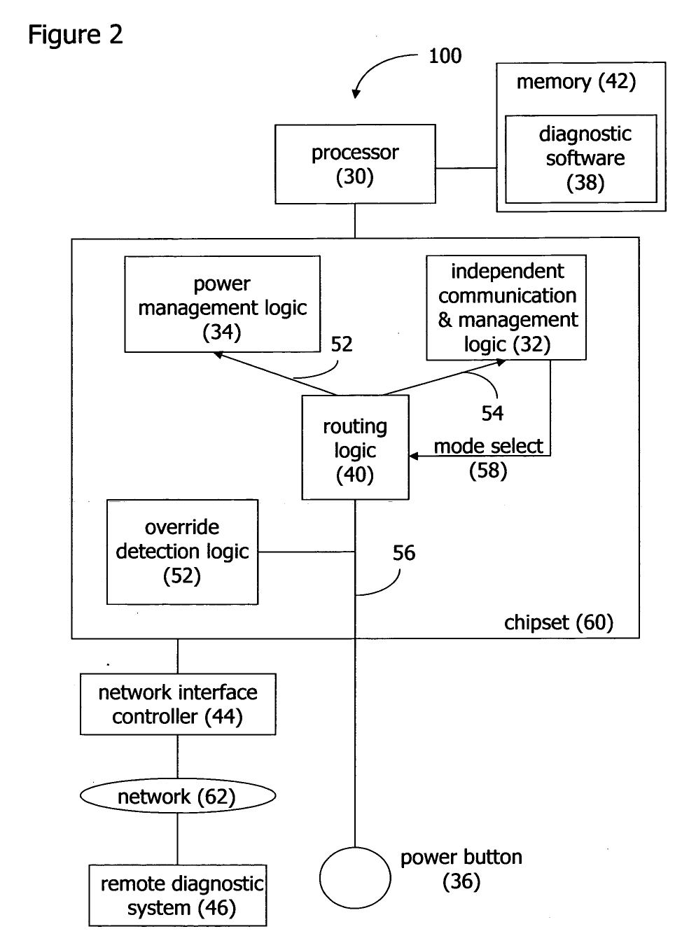

In those circumstances where user “permission” to allow a remote authority to control the processor-based system, the power button may include an “opt-in” feature. The “opt-in” feature changes the meaning of the power button temporarily from the already multiple meanings indicated in Table 1. In FIG. 2, for example, a processor-based system 100 is featured, according to one embodiment. The processor-based system 100 includes a processor 30 coupled to a chipset 60 which, in turn, is coupled to a power button 36. The chipset 60 includes power management logic 34 and override detection logic 52. In contrast to the chipset 20 of FIG. 1, the chipset 60 further includes independent communication and management logic 32 and routing logic 40. Independent communication logic 32 allows for communication between the processor-based system 100 and a remote system, where the communication is independent of and not dependent on the typical channels for communication between devices, such as through operating systems loaded on the systems. In one embodiment, the independent communication and management logic 32 conforms to an active management technology (AMT), an embedded technology which allows remote access to processor-based systems, such as for repair. AMT is intended to provide “out-of-band access” so as to enable the system to be repaired from a remote system. (AMT is a product of Intel Corporation of Santa Clara, Calif.)

When depressed by the user, the power button 36 produces a signal 56 which is received by the routing logic 40. The routing logic then send either a signal 52 to the power management logic 34 (power management mode) or a signal 54 to the independent communication and management logic 32 (independent management mode). In one embodiment, the routing logic 40 is a 2:1 demultiplexer, including a mode select 58 which is controlled by the independent communication and management logic 32. In a second embodiment, the routing logic 40 represents two modes of the processor 30. In a first mode, the processor 30 implements the power management logic 34; in a second mode, the processor 30 implements the independent communication and management logic 32. The chipset 50 also includes override detection logic 52, which identifies a “forced power off” request by the user. In one embodiment, the forced power off is available to the user of the processor-based system 100, irrespective of whether the system is in power management mode or independent management mode.

Coupled to the processor 30 is a memory 42, which may itself include a memory controller (not shown). Optionally, the processor-based system 100 includes diagnostic software 38, loaded into the memory 42. The diagnostic software 38 may be firmware, such as is stored in a read-only memory (ROM) or flash memory device, then loaded into the memory 42, or application software executed once the system 100 is fully in its on state. As will be shown, below, the diagnostic software 38 may enable the user to perform limited local diagnostics on the processor-based system 100.

Also coupled to the chipset 50, a network interface controller 44 provides a connection between the processor-based system 100 and other systems via a network 62. A remote diagnostic system 46 is depicted in FIG. 2, also coupled to the network 62. As will be described below, upon receipt of “permission” by the user of the processor-based system 100, the remote diagnostic system 46, coupled with the independent communication and management logic 32, is capable of remotely diagnosing the processor-based system 100, as well as performing remediation operations to fix the processor-based system, once issues therein are diagnosed. In the following passages, reference to diagnostics and/or diagnosis, particularly reference to the remote diagnostics software 38, is meant to include remediation (problem solving) capability as well as diagnostic (problem identification) capability.

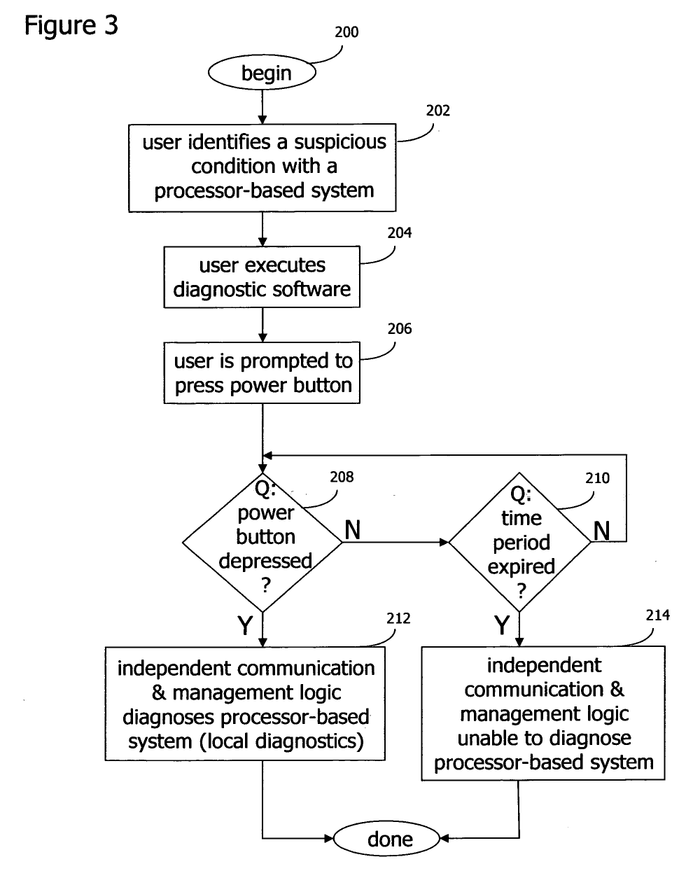

Two methods for using the processor-based system 100 are envisioned, as depicted in FIGS. 3 & 4. In a first usage model, the user exploits the independent communication and management logic 32 and diagnostic software 38 to locally repair the processor-based system 100 (local diagnostics). In the second usage model, the user of the processor-based system 100 contacts the user of the remote diagnostic system 46, such as a customer support person, to assist in identifying and repairing the processor-based system 100 (remote diagnostics). For each usage model, the meaning of the power button temporarily changes, enabling the user to give “permission” for the diagnostics to take place.

In FIG. 3, a flow diagram is used to illustrate the first usage model. First, the user identifies a suspicious condition with the processor-based system 100 (block 202). The user then executes the diagnostic software 38, if possible (block 204). The diagnostic software 38 prompts the user to press the power button 36 (block 206). This prompting may be in the form of a message displayed on the video display, an audio indicator, or other means.

At this point, the meaning of the power button 36 changes. The independent communication and management logic 32 of the chipset 50 changes the mode select signal 58 so that the routing logic 40 will send the signal 54 to the independent communication and management logic 32, once the user presses the power button 36. Accordingly, in the flow diagram of FIG. 3, a query is made as to whether the power button has been depressed (block 208). In one embodiment, the processor-based system allows the user some pre-determined time period in which the meaning of the power button 36 has changed. Alternatively, visual or audible indicators may indicate the time period in which the user may grant “permission” for diagnostics to take place.

If the user has not pressed the power button, a query is made as to whether the time period has expired (block 210). If not, blocks 208 and 210 are repeated until either the time period expires (the “yes” prompt of block 210) or the power button 36 has been pressed by the user (the “yes” prompt of block 208). Where the time period expires, the independent communication and management logic 32 is unable to diagnose the processor-based system 100 (block 210). Where, instead, the user depresses the power button 36, the independent communication and management logic 32 performs local diagnostics on the processor-based system 100 (block 214). In this manner, the user has controlled the execution of the independent communication and management logic 32 by giving “permission” via the power button 36, for performing local diagnostics. In one embodiment, once “permission” is given, the logic 32 enables diagnostics code from the remote diagnostic system 46 to be downloaded to the processor-based system 100 and executed thereon.

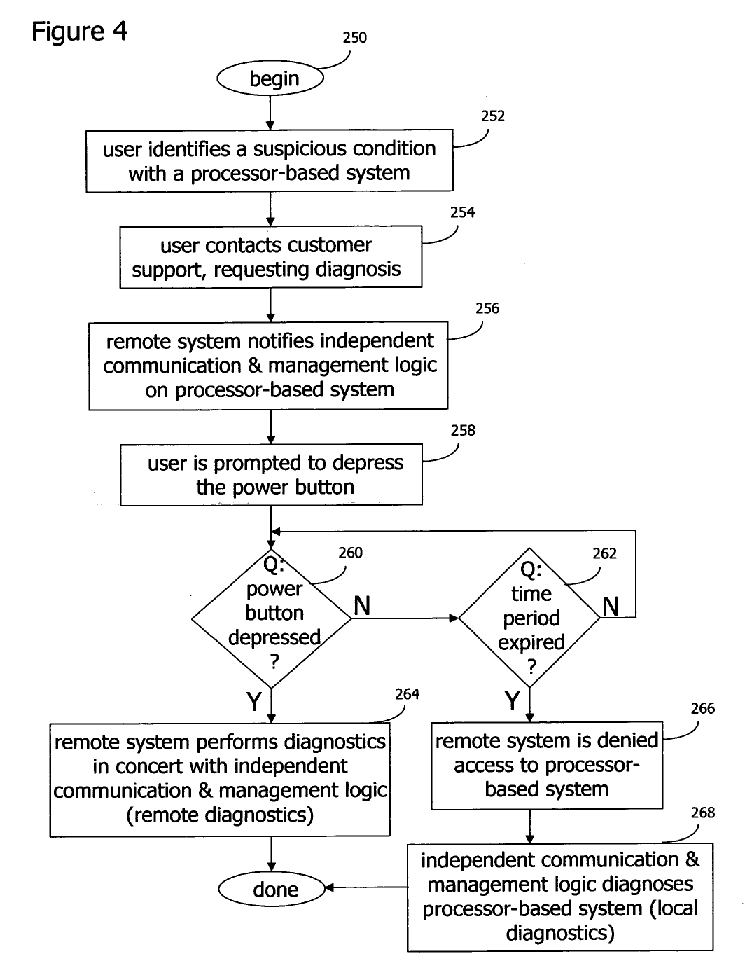

An alternative usage model is depicted is the flow diagram of FIG. 4, according to one embodiment. Again, the user identifies a suspicious condition with the processor-based system 100 (block 252). This time, the user contacts a user of the remote diagnostic system 46, such as a customer support person (block 254). The remote diagnostic system 46 notifies the independent communication and management 32 located on the processor-based system 100 (block 256). In one embodiment, when the independent communication and management logic 32 is contacted by the remote diagnostic system 46 (block 256), the mode select 58 to the routing logic 40 is changed, thus changing the meaning of the power button 36 (“permission” mode).

At some point during the call, the user is prompted to press the power button 36 (block 258). In one embodiment, the customer service representative of the remote diagnostic system 46 instructs the user to press the power button 36. In a second embodiment, the independent communication and management logic 32 causes a visual or audio indicator, such as a message on the video display, to prompt the user, thus encouraging the user to depress the power button 36.

As with the usage model of FIG. 3, the flow diagram of FIG. 4 includes two queries (blocks 260 & 262), indicating that the user is to depress the power button 36 within a pre-determined time period. In one embodiment, the processor-based system 100 is in permission mode indefinitely. In another embodiment, the user is given a limited period of time, such as five minutes, in which to depress the power button 36.

Once the power button 36 has been depressed, the remote diagnostic system 46 performs diagnostics on the processor-based system 100 in concert with the independent communication and management logic 32 (remote diagnostics) (block 264). In one embodiment, once “permission” is given, the logic 32 enables diagnostics code from the remote diagnostic system 46 to be downloaded to the processor-based system 100 and executed thereon. If, instead, the user does not depress the power button 36 within the pre-determined time period, the remote diagnostic system 46 is denied access to the processor-based system 100 (block 266).

Optionally, the independent communication and management logic 32, perhaps in concert with the diagnostic software 38, may perform diagnostics on the processor-based system 100 (local diagnostics) (block 268). In one embodiment, the independent communication and management logic 32 is able to perform limited functions, such as the limited diagnostic and remediation functions available in legacy processor-based systems. Thus, remote diagnostics are available to the processor-based system 100 only where the user presses the power button 36 during the permission mode of the processor-based system; where the user fails to depress the power button 36, local diagnostics, such as operations available in legacy processor-based systems may optionally be performed, or diagnostics operations are not performed on the processor-based system at all.

In one embodiment, the processor-based system 100 enables the user to separately give permission for diagnosis and remediation of the system, a two-step process. Thus, following a first “permission,” in which the user depresses the power button 36 during permission mode, the independent communication and management logic 32 maintains the permission mode of the processor-based system 100. A diagnosis of the condition of the processor-based system 100 is made by the remote diagnostic system 48 during this time. Once a solution is available, the user may again depress the power button 36, since the system continues to be in permission mode. This second “permission” event gives the remote diagnostic system 48 access to the processor-based system 100 in order to perform the remediation tasks. Following the second “permission” event, the independent communication and management logic 32 may bring the processor-based system 100 out of its permission mode so that the power button will be available for legacy operations.

In another embodiment, the processor-based system 100 is taken out of permission mode shortly after the user depresses the power button 36 for the first “permission” event (diagnosis), then the independent communication and management logic 32 returns the system 100 to permission mode for the second “permission” event (remediation). System designers of ordinary skill in the art will recognize a number of ways in which permission mode may be configured to enable remote diagnosis and remediation of the processor-based system 100. While the first task (diagnosis) by the remote diagnostic system 48 is somewhat invasive of the processor-based system 100, as various scans of the system 100 are performed, the second task (remediation) is arguably more invasive, as the configuration/state of the system 100 will likely be changed. Thus, some system designers may prefer to include separate permission events for each of the remote access operations.

Table 2 is an examination of the power button operations available in the processor-based system 100 of FIG. 2. Permission mode of the processor-based system 100 is available when the system is in an on state. When the user depresses the power button 36, the system 100 continues to be on and available to the user. Concurrently, however, the remote diagnostic system 46 has access to the processor-based system 100. (While the system may technically be available to the user, the customer support representative may instruct the user not to use the system during remote diagnostic operations.)

TABLE 2
Power Button Operation

| system states | power button action | resulting system state |
|---|---|---|
| OFF | short press | ON |
| OFF | long press | OFF |
| ON | short press | standby mode |
| ON | long press | OFF |
| standby mode | short press | ON |
| standby mode | long press | OFF |
| permission mode (ON) | short press | ON/remote access |
| permission mode (ON) | long press | OFF |

When the system is either in standby mode or in an off state, the permission mode is not available until the system state is restored to the on state by the user. For some of the actions listed in Table 2, there may be intermediate states. For example, when the system is in the standby mode, a long press of the power button may cause the system to first return from the standby mode prior to entering the off state.

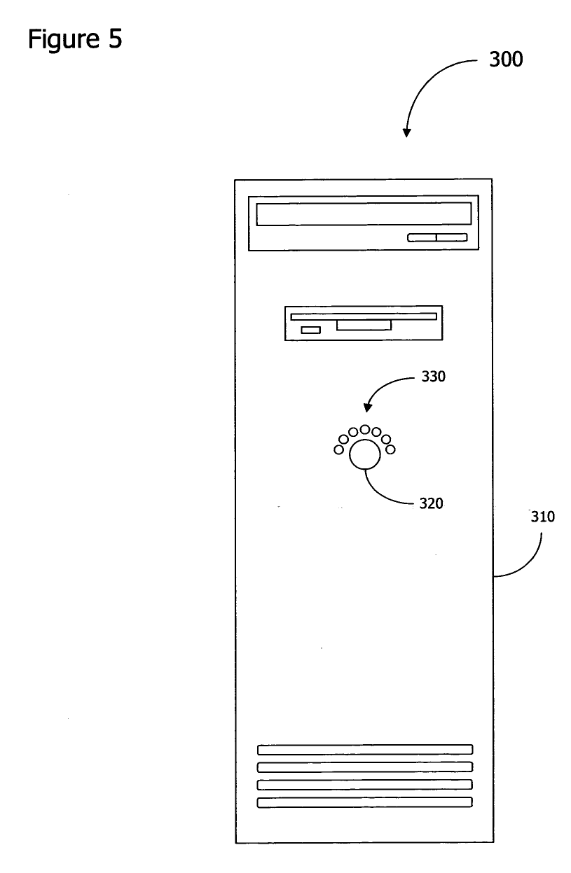

In some processor-based systems, the power button is associated with one or more visual indicators, such as LEDs, liquid crystal displays (LCDs), alphanumeric text displays, or another technology designed to inform the user that the processor-based system is in permission mode. In FIG. 5, for example, a processor-based system 300 includes a front panel 310 with a power button 320 and a set of LEDs 330, according to one embodiment. The LEDs 330 are used to provide visual indication of the system state, and may thus be used to apprise the user that the system is in permission mode, as described above. In Table 3, possible LED states for three hypothetical systems 400, 500, 600 are given, to show that the LED indicators may provide the user of a processor-based system with useful information about the system state. The systems of Table 3 represent a few of the many configurations possible for using the LEDs to indicate the system state.

TABLE 3
LED Indicators by System State

| | LED indicators | LED indicators | LED indicators |
|---|---|---|---|
| | first system | second system | third system |
| system state | (400) | (500) | (600) |
| OFF | off state | off state | off state |
| ON | continuous green | fast blink | all LEDs on |
| Standby | continuous amber | slow blink | some LEDs on |
| permission mode | alt. green/amber | continuous | LEDs blink |

In each of the three systems, it is presumed that the LEDs are off when the system is in the off state, since the LEDs have a small, but finite, power requirement. In the first system 400, the LEDs may be one of two colors, such as green or amber, and all LEDs are continuously lit. Thus, a first color (green) may indicate that the system 400 is in an on state while a second color (amber) may indicate that the system 400 is in standby mode. During permission mode, the LED indicators may alternate between the two colors, as one example.

In the second system 500, instead of being continuously driven, the LED indicators are periodically luminous, with a fast blink of the LEDs indicating the on state and a slow blink indicating the standby state. For permission mode of the system 500, the LEDs may be continuous, as one example. In the third system 600, the presence of multiple LEDs associated with the power button is exploited. When the system 600 is on, all LEDs are in an on state, while less than all of the LEDs are on when the system 600 is in standby mode, thus distinguishing the two modes. When the system 600 is in permission mode, the LEDs may be periodic, whether fast or slow blinking, as one example.

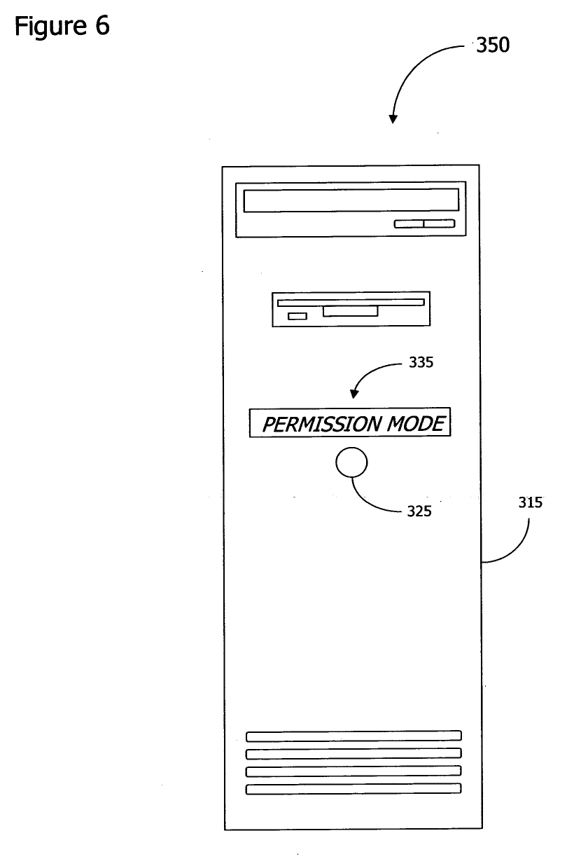

In FIG. 6, a processor-based system 350 includes an alphanumeric display panel 335 associated with a power button 325, according to one embodiment. The alphanumeric display panel 335 provides visual indication of the system state, in this case, “permission mode,” and may thus be used to apprise the user of the system state. The alphanumeric display panel 335 may be an LCD display, an electrophoretic display, an electroluminescent display, to name but a few examples.

System designers of ordinary skill in the art recognize many possibilities for providing visual indication to the user of the system state. New display technologies are emerging which may supplant the use of LEDs, LCDs, and other technologies currently in use. Furthermore, the processor-based system may include audio indicators, such as periodic beeps, to indicate a change in the system to the permission mode. The audio indicators may be presented in conjunction with the visual indicators, or may be distinct from visual indications, perhaps depending on the environment, user preference, and other considerations.

While the usage models described above (FIGS. 3 and 4) describes the use of the power button to grant permission for local and remote diagnostics, the permission mode may be used to enhance the processor-based system 100 in other ways. For example, user control using the power button 36 (permission mode) may allow remote control of the platform, such as remote use of a keyboard or mouse. Or, such user control may be used perform a BIOS update to the system configuration or rebuild the disk image. Thus, user permission can operate as a gate, limiting access to and control of the processor-based system.

Thus, a system and method for using the power button of a processor-based system to grant permission, for whatever use, is disclosed. The functionality of legacy processor-based systems is maintained, except during the permission mode of the system. The enhanced power button provides a secure method for granting permission by the user of the processor-based system, thus facilitating remote access to the system.

While the invention has been described with respect to a limited number of embodiments, those skilled in the art will appreciate numerous modifications and variations therefrom. It is intended that the appended claims cover all such modifications and variations as fall within the true spirit and scope of the invention.

I claim:

1. A processor-based system, comprising:
a user-accessible button, for producing a signal;
power management logic, for putting the processor-based system into a low power state;
independent communication and management logic, for enabling remote access to the processor-based system; and
routing logic coupled to the user-accessible button, wherein the routing logic selectively routes the signal to either the power management logic or the independent communication and management logic;
wherein the signal is routed to the independent communication and management logic if a user depresses the user-accessible button when the processor-based system is in a permission mode.

2. The processor-based system of claim 1, further comprising:
a mode select signal coupled to the routing logic and controlling the selective routing of the signal, the mode select signal having a first state and a second state, wherein the processor-based system is in the permission mode when the mode select signal is in the first state.

3. The processor-based system of claim 2, wherein the mode select signal is controlled by the independent communication and management logic.

4. The processor-based system of claim 1, wherein the user-accessible button is a power button located on a front panel of the processor-based system.

5. The processor-based system of claim 1, further comprising:
override detection logic for disabling power to the processor-based system when the user-accessible button is depressed by the user for a time period exceeding a predetermined time period;
wherein the override detection logic operates whether the processor-based system is in permission mode or not.

6. The processor-based system of claim 2, wherein the routing logic routes the signal to the power management logic when the mode select signal is in the second state.

7. The processor-based system of claim 1, further comprising:
one or more visual indicators associated with the user-accessible button, the one or more visual indicators being displayed in a first configuration when the processor-based system is in its on state, displayed in a second configuration when the processor-based system is in a standby mode, and displayed in a third configuration when the processor-based system is in the permission mode.

8. The system of claim 1, wherein the independent communication and management logic ends the permission mode of the processor-based system shortly after the user-accessible button is depressed during the permission mode.

9. The system of claim 1, wherein the signal is not capable of being produced by malicious software, whether the malicious software is loaded on the processor-based system or loaded on another system accessible to the processor-based system by way of a network.

10. A method, comprising:
identifying a suspicious condition of a processor-based system;
entering a permission mode by the processor-based system by executing independent communication and management logic in the processor-based system; and
waiting for permission from a user of the processor-based system to allow diagnostics to be performed on the processor-based system.

11. The method of claim 10, entering a permission mode by the processor-based system further comprising:
executing diagnostic software on the processor-based system, wherein the diagnostic software causes the independent communication and management logic to temporarily put the processor-based system in the permission mode.

12. The method of claim 11, further comprising:
obtaining permission from the user of the processor-based system, wherein the permission is obtained when the user depresses a user-accessible button of the processor-based system;
transmitting a signal to the independent communication and management logic of the processor-based system, wherein the signal cannot be generated by software; and
giving access of the processor-based system to a remote diagnostic system by the independent communication and management logic.

13. The method of claim 12, giving access of the processor-based system to a remote diagnostic system by the independent communication and management logic further comprising:
enabling the remote diagnostic system to download problem identification software to the processor-based system; and
enabling the remote diagnostic system to download remediation software to the processor-based system;
wherein the independent communication and management logic executes the problem identification and remediation software on the processor-based system.

14. The method of claim 10, entering a permission mode by the processor-based system further comprising:
changing a visual indicator on the processor-based system such that the visual indicator is in a unique state when the processor-based system is in the permission mode.

15. The method of claim 10, entering a permission mode by the processor-based system further comprising:
contacting a user of a remote diagnostic system, the remote diagnostic system being coupled to the processor-based system across a network, wherein the remote diagnostic system notifies the independent communication and management logic on the processor-based system, and the independent communication and management logic puts the processor-based system into the permission mode for a limited time period.

16. An article comprising a medium storing instructions to enable a processor-based system to:
identify a suspicious condition of a processor-based system;
enter a permission mode by the processor-based system by executing independent communication and management logic in the processor-based system; and
wait for permission from a user of the processor-based system to allow diagnostics to be performed on the processor-based system.

17. The article of claim 16, further storing instructions to enable a processor-based system to:
execute diagnostic software on the processor-based system, wherein the diagnostic software causes the independent communication and management logic to temporarily put the processor-based system in the permission mode.

18. The article of claim 17, further storing instructions to enable a processor-based system to:
obtain permission from the user of the processor-based system, wherein the permission is obtained when the user depresses a user-accessible button of the processor-based system;
transmit a signal to the independent communication and management logic of the processor-based system, wherein the signal cannot be generated by software; and
give access of the processor-based system to a remote diagnostic system by the independent communication and management logic.

19. The article of claim 18, further storing instructions to enable a processor-based system to:
change a visual indicator on the processor-based system such that the visual indicator is in a unique state when the processor-based system is in the permission mode.

20. The article of claim 19, further storing instructions to enable a processor-based system to:
contact a user of a remote diagnostic system, the remote diagnostic system being coupled to the processor-based system across a network, wherein the remote diagnostic system notifies the independent communication and management logic on the processor-based system, and the independent communication and management logic puts the processor-based system into the permission mode for a limited time period.
